(19) United States
(12) Patent Application Publication
(10) Pub. No.: US 2026/0253051 A1
(43) Pub. Date: Aug. 27, 2026

(54) LINKED SMART ACCOUNTS

(71) Applicant: Coinbase, Inc., Oakland, CA (US)

(72) Inventors: Wilson Cusack, Sedgwick, ME (US); Lukas Rosario, New York City, NY (US); Conner Swenberg, San Francisco, CA (US); Tina He, New York City, NY (US); Mind Apivessa, New York City, NY (US); Jake Feldman, Boulder, CO (US); Felix Zhang, San Francisco, CA (US); Montana Wong, Miami, FL (US); Alexandra Fitzroy, San Francisco, CA (US)

(21) Appl. No.: 19/064,676

(22) Filed: Feb. 26, 2025

(51) Int. Cl. G06Q 20/10; G06Q 20/36; G06Q 20/40; H04L 9/00

(52) U.S. Cl. CPC G06Q 20/10; G06Q 20/36; G06Q 20/401; H04L 9/50; H04L 2209/56

(57) ABSTRACT

Methods, systems, and devices for data management are described. Techniques described herein may enable a user to link one or more blockchain wallet accounts such that a global wallet may be used to fund multiple application-specific smart accounts. For example, the user may create an application-specific smart account and may add the global smart wallet as an owner of the application-specific smart account. The user may accordingly transfer an amount of crypto to one or more destination addresses associated with the client applications by enabling the global smart account to transfer the amount of crypto token to the respective application-specific smart account. Additionally, a smart contract may be provided permissions to allow spends from the global smart account by third-party applications associated with the application-specific wallet.

### FIELD OF TECHNOLOGY

The present disclosure relates generally to data management, including techniques for linked smart accounts.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports linked smart accounts in accordance with aspects of the present disclosure.

FIG. 2 shows an example of a computing environment that supports linked smart accounts in accordance with aspects of the present disclosure.

FIG. 3 shows an example of a graphical user interface (GUI) flow that supports linked smart accounts in accordance with aspects of the present disclosure.

FIG. 4 shows an example of a GUI that supports linked smart accounts in accordance with aspects of the present disclosure.

FIG. 5 shows an example of a process flow that supports linked smart accounts in accordance with aspects of the present disclosure.

FIG. 6 shows a block diagram of an apparatus that supports linked smart accounts in accordance with aspects of the present disclosure.

FIG. 7 shows a block diagram of a client application that supports linked smart accounts in accordance with aspects of the present disclosure.

FIG. 8 shows a diagram of a system including a device that supports linked smart accounts in accordance with aspects of the present disclosure.

FIG. 9 shows a block diagram of an apparatus that supports linked smart accounts in accordance with aspects of the present disclosure.

FIG. 10 shows a block diagram of a wallet manager that supports linked smart accounts in accordance with aspects of the present disclosure.

FIG. 11 shows a diagram of a system including a device that supports linked smart accounts in accordance with aspects of the present disclosure.

FIGS. 12 and 13 show flowcharts illustrating methods that support linked smart accounts in accordance with aspects of the present disclosure.

### DETAILED DESCRIPTION

A user may transfer a crypto token from a blockchain wallet to another blockchain address to pay for a product, access a service, etc. For example, the user may access a client application (e.g., a third-party application, a decentralized application (dApp)) to make the transfer from the blockchain wallet. In some cases, the blockchain wallet is an example of a smart wallet that is usable via a passkey accessible via a device of the user and supported by a smart contract that holds the tokens associated with the wallet. The smart wallet may be associated with a specific service provider in that the service provider may be able to validate that the correct passkey was used to sign a transaction. Thus, in one example, a user may accordingly open a smart wallet associated with a smart wallet service (e.g., provided by a custodial token platform). In some examples, some third-party applications (e.g., applications unassociated with the smart wallet provider, such as the custodial token platform) may provide support for smart wallets. However, to access such applications, the user may open another smart account specific to the third party application. To transact via the new smart account specific to the third party application, the user may be required to fund the new smart account from another wallet or account (e.g., the original smart wallet or another wallet). That is, the user may create and fund separate smart accounts for each application for which the user desires to interact with (e.g., transfer tokens), and the assets (e.g., crypto tokens) may be fragmented across multiple addresses/accounts Additionally, should the user stop using a given client application or if the client application no longer supports smart account functionalities or is terminated (e.g., shut down), the user may lose access to the tokens stored in the respective smart account.

Accordingly, techniques described herein may enable the user to use the global account (e.g., global smart wallet) to manage assets across multiple application-specific smart accounts (e.g., sub-accounts) via a unified user interface. This user interface (e.g., provided by the smart wallet service provider) may be accessible and usable even if the applications associated with specific sub-accounts are shut down. For example, the user may create an application-specific smart account and may add the global smart wallet as an owner of the application-specific smart wallet (e.g., using on-chain transactions or messages).

Additionally, the application-specific accounts may be provided permissions that allow the application-specific accounts to transact on-behalf of (e.g., spend tokens from) the global wallet. Thus, because the sub-accounts have spend permissions on the global account, the application-specific accounts can use access from the global accounts (without needing to be prefunded). The user (or the third-party application, based on the permissions) may accordingly transfer an amount of crypto to one or more destination addresses associated with the client applications by causing the global smart wallet to transfer the amount of crypto token to the respective application-specific smart accounts. Such techniques may provide the user with relatively more control over tokens owned by the user by storing the funds in a user controlled wallet (e.g., as compared to funds that are stored across a plurality of application-specific accounts). Additionally, such techniques may enable the user to create and use application-specific accounts without individually funding each wallet, which may improve user experience. Additionally, such techniques may lead to improved token security, because if a third-party application associated with one of the application-specific wallets terminates (e.g., is no longer accessible or is shut down), the user is able to control the application-specific wallets based on being designated as an owner of the application-specific wallet.

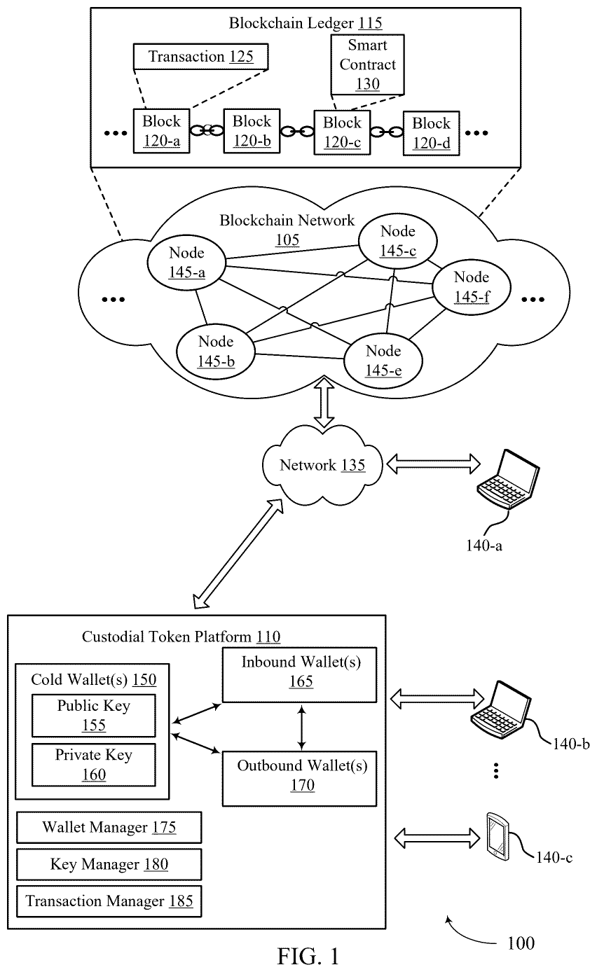

FIG. 1 illustrates an example of a computing environment 100 that supports linked smart accounts in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“dApp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the computing environment 100, a user may open a smart wallet associated with the custodial token platform 110. The smart wallet may be a wallet associated with a blockchain address via which the user may transfer crypto tokens as described herein. In some examples, the smart wallet (e.g., smart account) may be configured to connect to a plurality of client applications (e.g., dApps). For example, the client applications may install an SDK associated with the custodial token platform 110 that may enable connection to the smart wallet. The user may accordingly use funds of the smart wallet to perform one or more purchases associated with the one or more client applications. Smart wallets, as described herein, may be passkey-based wallets. A passkey may be an example of a digital credential bound to a user account, such as an email account, or a hardware device and a website or application, such as a client application or a blockchain address application as described herein. In other words, passkeys may be associated with user accounts or hardware devices and may be uniquely bound to a domain. For example, passkeys may be stored at a location that is associated with the user account or hardware device (e.g., in a secure enclave, a cloud, on the hardware device, etc.). Additionally, passkeys may be usable on the domain that they are bound to (e.g., and not on other domains). Creating a smart wallet may involve creating a passkey. For example, a user may create a passkey bound to a user account (e.g., of the client application, or a different account) and bound to a domain of the client application. The passkey may be used to encrypt a private key. Additionally, smart wallets may not involve recovery phrases (e.g., recovery phrases for externally owned account (EOA) wallets).

The interaction between passkeys, smart wallets, and smart contracts creates a seamless and secure blockchain experience. When a user initiates a transaction or interaction with a decentralized application (dApp), the smart wallet's associated smart contracts handle the programmatic logic and execution, while the passkey system manages the authentication and authorization process through biometric verification. This integration allows users to securely approve transactions and interact with smart contracts using biometric (or another type of) authentication, rather than managing complex private keys or seed phrases. The smart contracts then execute the predetermined logic, whether the logic supports a token swap, DeFi interaction, or other blockchain transaction, while maintaining the security and programmability benefits of the smart wallet system. This three-way interaction effectively combines the security of modern authentication methods with the flexibility of smart contracts and the enhanced functionality of smart wallets.

In some examples of the computing environment 100, a user may open a plurality of application-specific smart accounts (e.g., account addresses associated with a respective plurality of client applications) that are linked to a global smart wallet. For example, the user may access the global smart wallet to manage the applications-specific accounts. Additionally, applications associated with the application-specific smart accounts may cause transfer of funds from the global smart wallet to each of the application-specific smart accounts and/or to other destination addresses. The application-specific smart accounts may be used to perform one or more additional blockchain transactions to transfer the tokens to destination addresses associated with respective client applications, which may enable the user to perform on-chain activities at each of the client applications using tokens stored at the global smart wallet (e.g., without having the user to sign each transaction to fund the application-specific smart accounts). The global smart wallet may be associated with or supported by the custodial token platform 110 or smart wallet service.

In some examples, a smart contract 130 (e.g., a spend permissions manager) of the blockchain network 105 may define and/or store one or more permissions associated with the global smart wallet and the plurality of application-specific smart accounts (e.g., sub-accounts). The spend permissions may be requested by a third-party application (e.g., a dApp) and may be signed by the global account. Such permissions may allow the sub-accounts or spender (e.g., dApp) to pull funds from the global account according to the rules defined in the permissions (e.g., an amount, period, frequency, expiration). In some cases, some smart-accounts may not be associated with spend permissions, but may still be controlled by the global accounts. That is, such smart accounts may not be provided permissions to allow spending by third-party application providers, but may be controlled via the global account/wallet based on the ownership designation, as described herein.

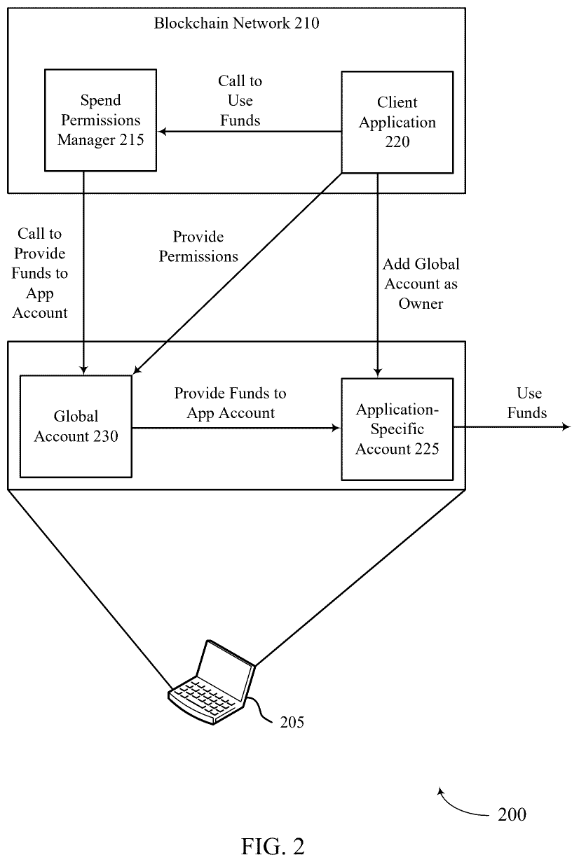

FIG. 2 shows an example of a computing environment 200 that supports linked smart accounts in accordance with aspects of the present disclosure. The computing environment 200 may implement or may be implemented by aspects of the computing environment 100. For example, the computing environment 200 may include a computing device 205, a blockchain network 210, and a spend permissions manager 215, which may examples of the corresponding devices as described with respect to FIG. 1.

In some examples of the computing environment 200, a user of a client application 220 may use one or more accounts of a custodial token platform associated with a computing device 205 to store and spend crypto tokens. For example, the user may spend funds from an application-specific account 225 (e.g., an application-specific blockchain wallet address), which may be an example of a smart account as described herein. The application-specific account 225 may be configured to broadcast one or more blockchain messages that may cause the transfer of an amount of crypto token from the application-specific account 225 to a destination address (e.g., a destination address associated with the client application 220 or provided by the client application 220) to complete a purchase at the client application 220 or otherwise interact with the network. In some examples, the user may use one or more additional application-specific accounts 225 to complete purchases associated with one or more additional client applications 220.

In some examples, however, funding individual application-specific accounts 225 for each client application 220 may worsen a user experience as a result of increased transaction times (e.g., in examples in which the user may exit the client application 220 to purchase additional funds for the application-specific accounts 225). Individually funding multiple application-specific accounts 225 may also result in a fragmentation of assets/tokens. Additionally, in some examples, the user may not spend all of the funds stored in the application-specific accounts 225, which may result in a loss of funds (e.g., if the user no longer uses the client application 220, if the client application 220 no longer supports use of the application-specific account 225, or if the client application 220 is abandoned or does not exist).

Each of the smart wallets/accounts described herein, such as the global account 230 and the application-specific account 225 may be associated with a respective smart contract on the blockchain network 210. For example, the global account 230 is associated with a global account smart contract, and the application-specific account 225 is associated with an application-specific smart contract. Thus, when a smart account is generated, a respective smart contract may be deployed in the blockchain network to support the smart wallet functionality. These smart contracts may include a set of predefined rules and conditions that govern aspects of basic transactions to complex interactions with other blockchain protocols and services. Additionally, when a smart contract is generated for a smart account, the computing device 205 is provided a passkey that is used to interact with and manage the associated smart wallet and corresponding smart contract. The passkey may be stored in a secure enclave of the computing device 205 and/or a cloud-based passkey manager.

To address management and security concerns with multiple application-specific accounts 225, techniques described herein may enable the user to link one or more accounts such that the user (with or without support from a client application 220) may manage multiple application-specific accounts 225 (e.g., sub-accounts) via a global account 230 (e.g., a global smart wallet, a global blockchain wallet address). A linked account or sub-account may be defined as an account that has another account (e.g., the global account 230) as the owner and that has a spend permission from the global account 230 to the linked account. Thus, the user may add the global account 230 as an owner of each application-specific account 225 (e.g., as an owner of a smart contract associated with each application-specific account 225). For example, the client application 220 may prompt the user to create the application-specific account 225 in response to a user selection to perform a transaction at the client application 220. The client application 220 may output, to the computing device 205, a call to link the application-specific account 225 with a global account 230 (e.g., to add the global account 230 as an owner on the smart contract of the application-specific account 225). The computing device 205 may display a prompt to the user based on the call from the client application 220, and the prompt may request that the user sign a transaction (e.g., payload) that includes information to add the global account 230 as an owner of the application-specific account 225. The user may provide one or more inputs to sign the transaction (e.g., using the private key/passkey associated with the application-specific account 225), and the transaction may be broadcast via the blockchain network to add the global account 230 as the owner of the application-specific account 225 (e.g., as an owner of the smart contract associated with the application-specific account). Thus, based on confirming the transaction, the blockchain network 210 (e.g., the corresponding ledger) documents that the global account 230 is an owner of the application-specific account 225.

To give the application-specific account 225 permissions to the global account 230, the client application 220 may transmit to the computing device 205 a request to add permissions. The user may approve the request at the computing device 205 (e.g., via one or more user inputs), which may result in a signature, by a private key/passkey of the global account 230, over a permissions payload. The permissions payload may include information such as spend amount, spend timeline/frequency, types of tokens approved for spending, etc. As an illustrative example, the user may indicate that the application-specific account 225 is permitted to spend a given amount of USDC per day. The signed permissions payload may be used by the client application 220 to spend funds from the global account 230 via the application-specific account 225. For example, the client application 220 may provide the signed permissions payload to the spend permissions manager 215, which may be a smart contract supported by the blockchain network 210. The spend permissions manager 215 may verify the signature over the permission payload and store the permissions for subsequent spending by the application-specific account 225 and/or the client application 220. Additionally, to support the techniques described herein, the spend permissions manager 215 may be designated as an owner of the global account 230. Thus, when the user approves the various requests described herein, one or more messages may be broadcast to the blockchain network such as to add the spend permissions manager 215 as the owner of the global account 230.

When the client application 220 wants to spend from the application-specific account 225 in accordance with the permissions, the client application 220 may call the spend permissions manager 215 (e.g., call to obtain funds), and the call may include an indication of the permissions, a destination address, and amount of tokens to spend. The spend permissions manager 215 may validate the information in the call (including the permissions) and execute the spend by broadcasting one or more messages via the blockchain network 210. In some examples, the spend permissions manager 215 may verify that the call to obtain funds is in accordance with the permissions indicated by the user. For example, the spend permissions manager 215 may verify that an amount of funds indicated by the call to obtain funds does not exceed the spend limit indicated by the permissions. In response to verifying the call to obtain funds, the spend permissions manager 215 may broadcast one or more messages that cause transfer of the tokens from the global account 230 to the application-specific account 225 and from the application-specific account to the destination address (e.g., use funds).

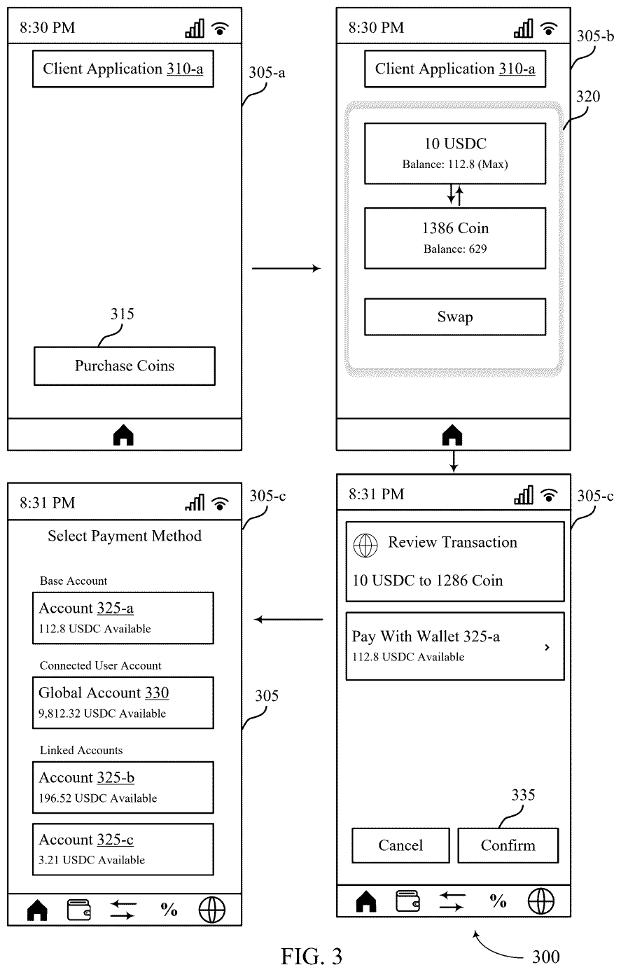

Thus, the spend permissions manager 215 may cause the global account 230 to transfer additional funds to the application-specific account 225 in accordance with the additional calls (e.g., until the spend limit indicated by the user is reached). Accordingly, the user and/or the client application 220 may transact using the application-specific account 225 using tokens stored at the global account 230 (e.g., without providing an additional signature for each transaction). Thus, the permissions and the spend permissions manager 215 may allow the client application 220 to leverage the application-specific account 225 to spend tokens from the global account 230. Additionally, as described in further detail in FIG. 3, the user may selectably spend funds from the application-specific account 225, using a unified user interface of the global account 230, to transact with one or more client applications, such as client application 220. In some examples, the user may create one or more additional application-specific accounts 225 associated with one or more additional client applications 220. The user may add the global account 230 as an owner of the one or more additional application-specific accounts 225 as described herein, which may enable the user to spend funds stored at the global account 230 at multiple client applications 220.

The global account 230 may be referred to as a “universal account,” in that it is used to manage multiple application-specific accounts 225. Additionally, since the application-specific accounts (e.g., the application-specific accounts 225) may be managed using the global account 230, the application-specific accounts may be referred to as “sub-accounts.” A wallet service provider that supports the techniques described herein (e.g., supports the global account 230) may provide a unified user interface that allows the user to manage multiple application-specific accounts 225, view various funds, tokens, balances associated with each, and spend tokens from each application-specific account 225 without requiring additional signature flows for each of the application-specific accounts 225.

FIG. 3 shows an example of a GUI flow 300 that supports linked smart accounts in accordance with aspects of the present disclosure. The GUI flow 300 may implement or may be implemented by aspects of the computing environment 100 or the computing environment 200. For example, the GUI flow 300 may be implemented or supported by a custodial token platform 110, a blockchain network 105, or a computing device 140 as described with reference to FIGS. 1 and 2.

In some examples, as described with reference to FIG. 2, a user provide input to perform an on-chain interaction with a client application 310-a via an account. For example, the user may make a selection 315 at a user interface page 305-a of a client application 310-a (e.g., via a user device) to perform an on-chain interaction with the client application 310-a using a first type of crypto token. In response to the selection by the user, the user interface page 305-b may display information 320 associated with a transaction, such as an indication of an amount of the crypto token, an available balance of crypto token, an indication of the interaction type (e.g., a swap), and the like.

In some examples, the user interface page 305-c (e.g., a universal UI associated with the global account 230 of the user) may display linked accounts associated with a global account 230. For example, the user interface page 305-c may display an indication of one or more blockchain addresses (e.g., the account 325-a associated with the client application 310-a, an account 325-b and an account 325-c associated with one or more other client applications 310) and the global account 330 that is linked to the one or more application-specific accounts (e.g., the accounts 325). In some examples, the user interface page 305-c may indicate a balance of crypto tokens available at each application-specific account and at the global account 330. The user may select an account (e.g., an application-specific account) from which the user may transfer the crypto token to complete the transaction at the client application.

Accordingly, as described with reference to FIG. 2, the computing device (e.g., or a wallet backend) may broadcast one or more blockchain messages that may cause transfer of the amount of crypto token from the selected application-specific account (e.g., the acount 325-a) to a destination address associated with the client application 310-a in response to a selection 335 by the user. For example, the computing device may transfer the token from the application-specific account rather than from the global account 330 to the destination address in response to the selection. In some examples, based on the global account 330 being an owner of the account 325-a (e.g., being an owner of a smart contract associated with the account 325-a), the one or more messages may cause transfer of the crypto token from the global account 330 to the application-specific account, and from the application-specific account to the destination address.

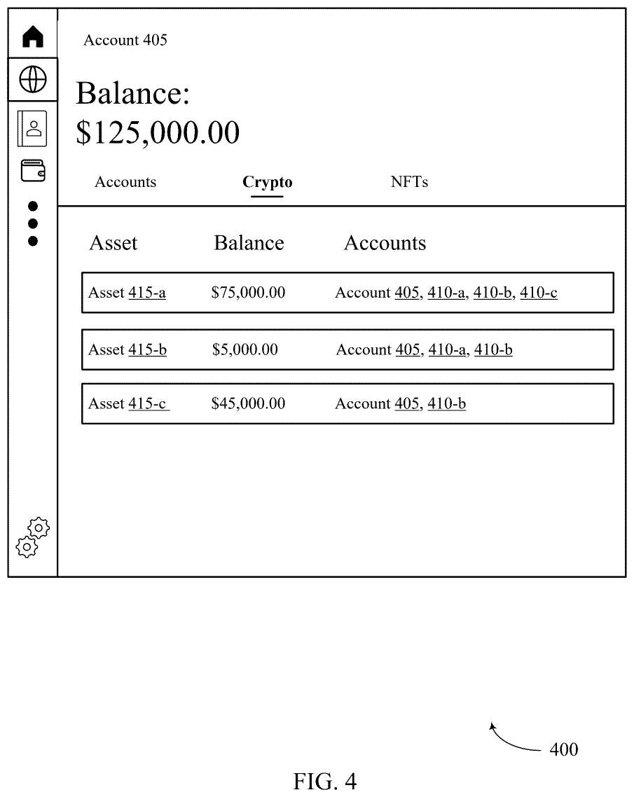

FIG. 4 shows an example of a GUI 400 that supports linked smart accounts in accordance with aspects of the present disclosure. The GUI 400 may implement or may be implemented by aspects of the computing environment 100, the computing environment 200, or the GUI flow 300. For example, the GUI 400 may be implemented or supported by a custodial token platform 110, a smart wallet service, a blockchain network 105, or a computing device 140 as described with reference to FIGS. 1 and 2.

In some examples, the GUI 400 may be an example of a user interface page of a smart wallet service (e.g., supported by the custodial token platform 110). The GUI 400 may display a balance of crypto tokens owned by a user, as well as one or more global accounts 405 and application-specific accounts 410 that may have access to the funds owned by a user. For example, the GUI 400 may display an indication of one or more types of crypto token (e.g., an asset 415-a, an asset 415-b, an asset 415-c) owned by the user, a balance of each asset 415 (e.g., a total value of each respective asset), the global account 405 of the user, and each linked application-specific account 410 that has some amount of the corresponding asset 415 based on the blockchain ledger. Thus, using the GUI 400 user may be able to identify where funds are stored across various accounts. A service supporting the GUI 400 may identify such information based on ownership designations (e.g., to identify linked accounts) on the blockchain ledger and display the information to the user. The GUI 400 may aggregate the total balances across the global account and linked accounts.

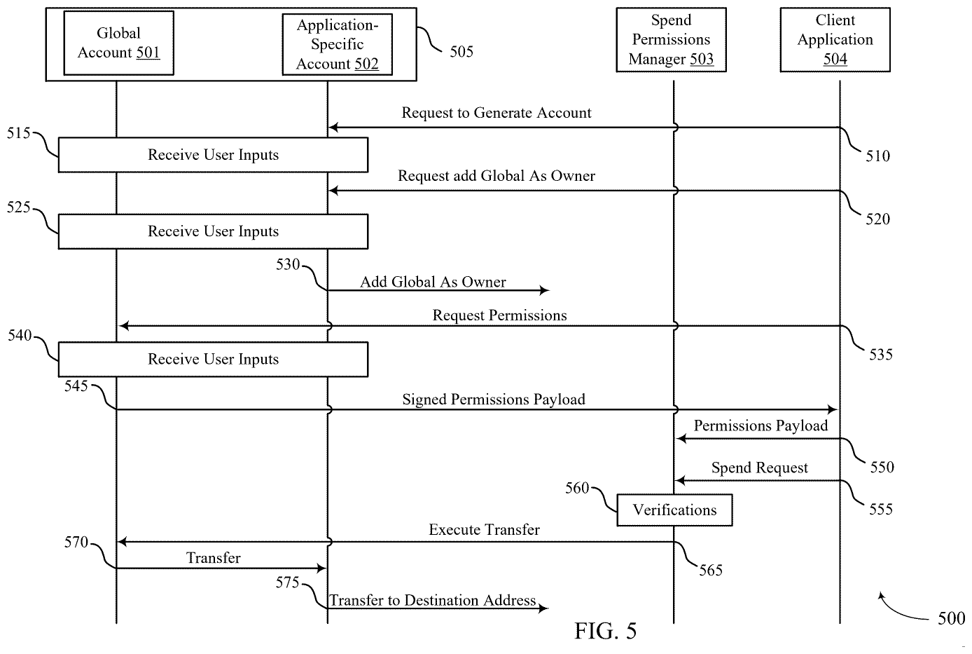

FIG. 5 shows an example of a process flow 500 that supports linked smart accounts in accordance with aspects of the present disclosure. The process flow 500 may implement or may be implemented by aspects of the computing environment 100, the computing environment 200, a smart wallet service, smart account service, the GUI flow 300, or the GUI 400. For example, the process flow 500 may include a computing device 505 and a client application 504, which may be examples of one or more components of the computing environment 100 and the computing environment 200.

In the following description of the process flow 500, the operations between the computing device 505, the global account 501, the spend permissions manager 503, and the client application 504 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At 510, the computing device 505 may receive a request from the client application 504 (e.g., a third-party client application) to generate an application-specific account 502. At 515, the computing device 505 may receive one or more user inputs to generate the application-specific account 502 and generate the application-specific account 502. The computing device 505 may store a passkey associated with the application-specific account 502.

At 520, the computing device 505 may receive, from the client application 504, a request to add the global account 501 as an owner of the application-specific account 502. At 525, the computing device 505 may receive one or more user inputs to confirm the request. In some cases, the one or more user inputs may result in a signature payload over a transaction/message that includes information that adds the global account 501 as the owner of the application-specific account 502. The signature may be based on the private key/passkey associated with the application-specific account 502. At 530, the computing device 505 (e.g., a wallet backend) may broadcast one or more messages via the blockchain network, and the one or more messages may include the information to add the global account 501 as the owner of the application-specific account 502. Thus, when the network verifies the transaction/messages, the ledger is updated to reflect that the global account is the owner of the application-specific account 502. In some cases, the request to generate the account at 510 may include the indication to add the global account 501 as the owner. Thus, when the application-specific account 502 is deployed, the global account 501 is listed as the owner. Accordingly, operations at 510 through 530 may be combined.

At 535, the computing device 505 may receive a request from the client application 504 to provide the application-specific account 502 with permissions to transfer funds from a global account 501. At 540, the computing device 505 may receive one or more user inputs to approve the permissions. t. The one or more user inputs at 540 may result in signing a permissions payload by a private key/passkey associated with the global account 501. The permissions payload may include information such as spend limit, spend frequency, token type, etc.

At 545, the computing device 505 may provide, to the client application 504, the signed permissions payload. At 550, the client application 504 may provide, to the spend permissions manager 503, the signed permissions payload (e.g., by broadcasting one or more messages via the blockchain network). The permissions payload may be provided based on a spend request or prior to a spend request. The spend permissions manager 503 may store the permissions for spend requests.

At 555, the client application 504 may transmit, to the spend permissions manager 503, a spend request. The spend request may be transmitted based on one or more messages broadcast via the blockchain network, and the one or more messages may include a call to the spend permissions manager 503. The call may include an identifier for the permissions (e.g., the permissions payload), an amount of crypto tokens, a destination address, or any combination thereof. At 560, the spend permissions manager 503 may perform verifications/validation of the spend request. For example, the spend permissions manager 503 may validate the permissions were validly approved and/or that the spend request amount is within the allowance defined by the permissions.

At 565, the spend permissions manager 503 may execute the transfer by broadcasting one or more messages via the blockchain network. The one or more messages may cause, at 570, the tokens to be transferred from the global account 501 to the application-specific account 502, and, at 575, from the application-specific account to the destination blockchain address.

In some cases, the computing device 505 may display information to the user. For example, the user device may display, via a unified user interface associated with the global account 501, an indication of one or more linked accounts, an indication of a balance of crypto token owned by the user, a prompt for the user to select the global account 501 or the application-specific account 502 for a transaction at the client application 504, and the like, as illustrated with reference to FIGS. 3 and 4. Thus, the user may access the unified user interface to spend tokens from one or more linked accounts, without requiring additional signatures for the linked accounts. Thus, The global account 501 may broadcast one or more blockchain messages to transfer an amount of crypto to or from the application-specific account 502. In some examples, the computing device 505 and the spend permissions manager 503 may perform one or more operations as described herein to generate an additional application-specific account, add the global account 501 as an owner of the application-specific account, and broadcast one or more messages to transfer funds from the global account 501 to the additional application-specific account and from the additional application-specific account to one or more destination addresses. Accordingly, the global account 501 may be linked with multiple application-specific accounts.

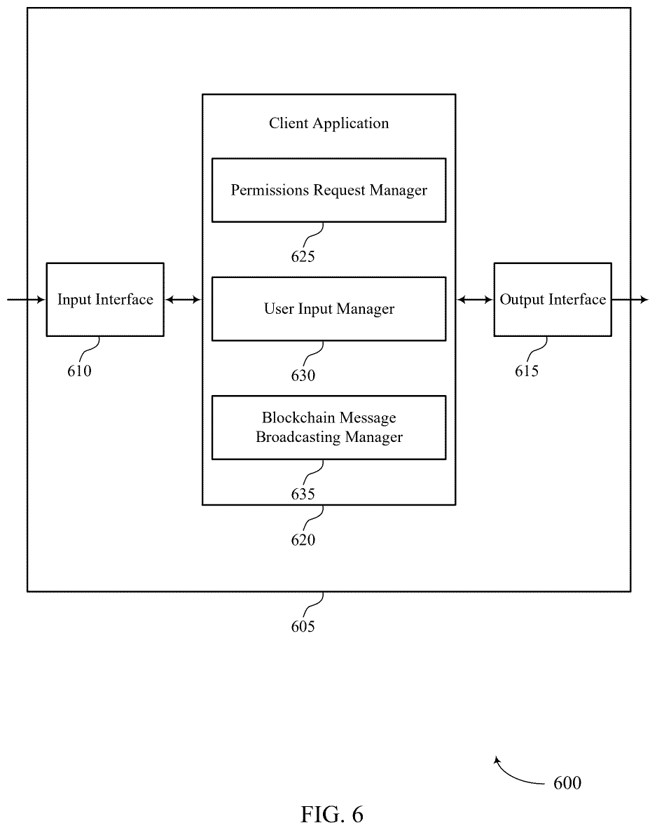

FIG. 6 shows a block diagram 600 of a device 605 that supports linked smart accounts in accordance with aspects of the present disclosure. The device 605 may include an input interface 610, an output interface 615, and a client application 620. The device 605, or one or more components of the device 605 (e.g., the input interface 610, the output interface 615, the client application 620), may include at least one processor, which may be coupled with at least one memory, to support the described techniques. Each of these components may be in communication with one another (e.g., via one or more buses).

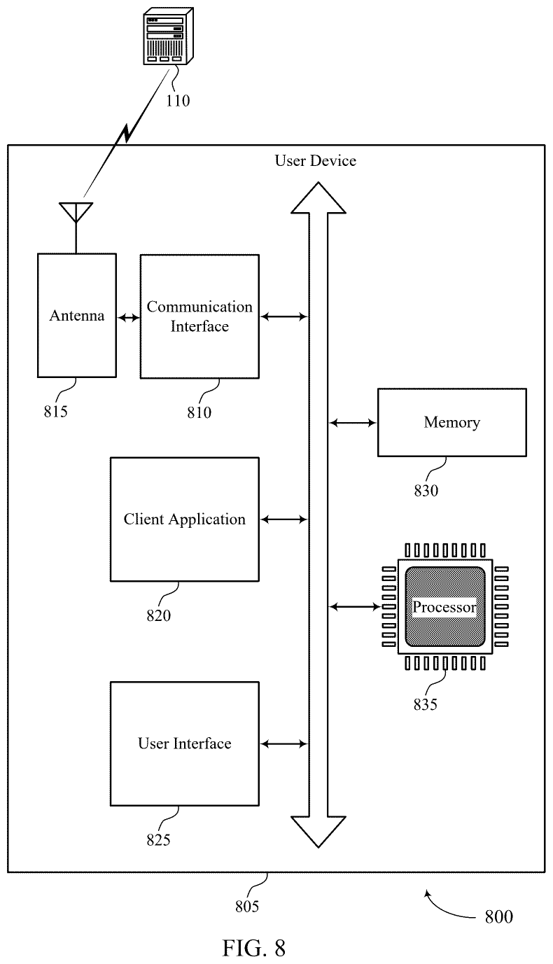

The input interface 610 may manage input signaling for the user device 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the user device 605 for processing. For example, the input interface 610 may transmit such corresponding signaling to the client application 620 to support linked smart accounts. In some cases, the input interface 610 may be a component of a user interface component 810 as described with reference to FIG. 8.

The output interface 615 may manage output signaling for the device 605. For example, the output interface 615 may receive signaling from other components of the device 605, such as the client application 620, and may transmit such output signaling corresponding to (e.g., representative of or otherwise based on) such signaling to other systems or devices. In some cases, the output interface 615 may be a component of a communication interface 810 as described with reference to FIG. 8.

For example, the client application 620 may include a permissions request manager 625, a user input manager 630, a blockchain message broadcasting manager 635, or any combination thereof. In some examples, the client application 620, or various components thereof, may be configured to perform various operations (e.g., receiving, monitoring, transmitting) using or otherwise in cooperation with the input interface 610, the output interface 615, or both. For example, the client application 620 may receive information from the input interface 610, send information to the output interface 615, or be integrated in combination with the input interface 610, the output interface 615, or both to receive information, transmit information, or perform various other operations as described herein.

The permissions request manager 625 may be configured as or otherwise support a means for receiving, at a user device and from a third-party client application, a first request to provide an application-specific blockchain address with permissions to transfer funds from a global blockchain address, wherein the global blockchain address is an owner of a first smart contract associated with the application-specific blockchain address. The user input manager 630 may be configured as or otherwise support a means for receiving, at the user device and after receiving the first request, one or more first user inputs that result in a signature over a payload. The blockchain message broadcasting manager 635 may be configured as or otherwise support a means for broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

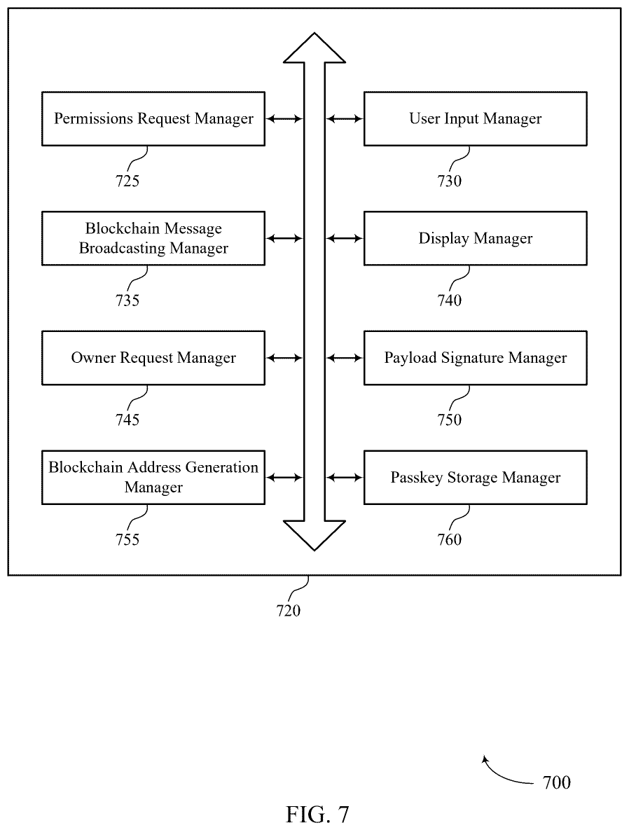

FIG. 7 shows a block diagram 700 of a client application 720 that supports linked smart accounts in accordance with aspects of the present disclosure. The client application 720 may be an example of aspects of a client application or a client application 620, or both, as described herein. The client application 720, or various components thereof, may be an example of means for performing various aspects of linked smart accounts as described herein. For example, the client application 720 may include a permissions request manager 725, a user input manager 730, a blockchain message broadcasting manager 735, a display manager 740, an owner request manager 745, a payload signature manager 750, a blockchain address generation manager 755, a passkey storage manager 760, or any combination thereof. Each of these components, or components of subcomponents thereof (e.g., one or more processors, one or more memories), may communicate, directly or indirectly, with one another (e.g., via one or more buses).

The permissions request manager 725 may be configured as or otherwise support a means for receiving, at a user device and from a third-party client application, a first request to provide an application-specific blockchain address with permissions to transfer funds from a global blockchain address, wherein the global blockchain address is an owner of a first smart contract associated with the application-specific blockchain address. The user input manager 730 may be configured as or otherwise support a means for receiving, at the user device and after receiving the first request, one or more first user inputs that result in a signature over a payload. The blockchain message broadcasting manager 735 may be configured as or otherwise support a means for broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

In some examples, the user input manager 730 may be configured as or otherwise support a means for receiving one or more second user inputs to transfer a first type of crypto token from the global blockchain address. In some examples, the display manager 740 may be configured as or otherwise support a means for displaying, at the user device, a user interface that includes one or more blockchain addresses linked to the global blockchain address and including the application-specific blockchain address. In some examples, the user input manager 730 may be configured as or otherwise support a means for receiving a third user input that selects, for supporting the transfer of the first type of crypto token, the application-specific blockchain address from the one or more blockchain addresses. In some examples, the blockchain message broadcasting manager 735 may be configured as or otherwise support a means for broadcasting, after receiving the third user input, one or more second messages that transfer the first type of the crypto token from the application-specific blockchain address instead of the global blockchain address.

In some examples, the one or more blockchain addresses are linked to the global blockchain address based at least in part on the global blockchain address being designated as the owner of each respective smart contract associated with one or more blockchain addresses.

In some examples, the one or more messages transfer the first type of crypto token from the global blockchain address to the application-specific blockchain address and from the application-specific blockchain address to a destination blockchain address.

In some examples, the owner request manager 745 may be configured as or otherwise support a means for receiving, from the third-party client application and prior to the first request, a second request to add the global blockchain address as the owner of the first smart contract associated with the application-specific blockchain address. In some examples, the payload signature manager 750 may be configured as or otherwise support a means for receiving, after receiving the second request, a second signature over a second payload, wherein the second signature is associated with the application-specific blockchain address. In some examples, the blockchain message broadcasting manager 735 may be configured as or otherwise support a means for broadcasting one or more second messages, the signed second payload that includes information that adds the global blockchain address as the owner of the first smart contract associated with the application-specific blockchain address.

In some examples, the blockchain address generation manager 755 may be configured as or otherwise support a means for receiving, at the user device and from the third-party client application, a second request to generate the application-specific blockchain address associated with the third-party client application. In some examples, the user input manager 730 may be configured as or otherwise support a means for receiving one or more second user inputs that result in generation of the application-specific blockchain address associated with the third-party client application. In some examples, the passkey storage manager 760 may be configured as or otherwise support a means for storing, at the user device, a passkey associated with the application-specific blockchain address.

In some examples, the display manager 740 may be configured as or otherwise support a means for displaying, at a user interface of the user device, an indication of the permissions requested by the third-party client application, wherein the one or more first user inputs are received after displaying the indication of the permissions.

In some examples, the display manager 740 may be configured as or otherwise support a means for displaying, at the user device, a user interface including a plurality of crypto tokens associated with the global blockchain address, wherein the plurality of crypto tokens includes one or more crypto token types associated with one or more blockchain addresses which are linked to the global blockchain address.

FIG. 8 shows a diagram of a system 800 including a device 805 that supports linked smart accounts in accordance with aspects of the present disclosure. The device 805 may be an example of or include components of a device 605 as described herein. The device 805 may include components for bi-directional voice and data communications including components for transmitting and receiving communications, such as a client application 820, a communication interface 810, one or more antennas 815, a user interface component 825, at least one memory 830, and at least one processor 835. Each of these components may communicate, directly or indirectly, with one another (e.g., via one or more buses, communications links, communications interfaces, or any combination thereof).

The communication interface 810 may manage input and output signals for the device 805 via the antenna 815. For example, the communication interface 810 may enable the user device 805 to exchange information (e.g., input information, output information, or both) with other systems or devices, such as custodial token platform 110 (e.g., supported by one or more servers), via one or more wired or wireless communication links. The communication interface 810 may also utilize or interact with antenna 815 to support communication with other systems or devices. In some cases, the communication interface 810 may represent a physical connection or port to an external peripheral, such as a hardware wallet device. In some cases, the communication interface 810 may utilize an operating system such as iOS®, ANDROID®, MS-DOS®, MS-WINDOWS®, OS/2®, UNIX®, LINUX®, or another known operating system. The communication interface 810 may be implemented as part of the processor 835.

In some cases, the device 805 may include a single antenna 815. However, in some other cases, the device 805 may have more than one antenna 815, which may be capable of concurrently transmitting or receiving multiple wireless transmissions. The communication interface 810 may communicate bi-directionally, via the one or more antennas 815, wired, or wireless links as described herein. For example, the communication interface 810 may represent a wireless transceiver and may communicate bi-directionally with another wireless transceiver. The communication interface 810 may also include a modem to modulate the packets, to provide the modulated packets to one or more antennas 815 for transmission, and to demodulate packets received from the one or more antennas 815.

The user interface component 825 may represent a keyboard, a mouse, a touchscreen, a microphone, or a similar device or component. In some cases, a user may interact with the user interface component 825. In other cases, the user interface component 825 may operate automatically without user interaction. The user interface component 825 may display or output information such as information received from other systems or devices or information to be transmitted to other systems or devices.

The memory 830 may include RAM and ROM. The memory 830 may store computer-readable, computer-executable software including instructions that, when executed, cause at least one processor 835 to perform various functions described herein. In some cases, the memory 830 may contain, among other things, a BIOS which may control basic hardware or software operation such as the interaction with peripheral components or devices. The memory 830 may be an example of a single memory or multiple memories. For example, the user device 805 may include one or more memories 830.

The processor 835 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 835 may be configured to operate a memory array using a memory controller. In other cases, a memory controller may be integrated into the processor 835. The processor 835 may be configured to execute computer-readable instructions stored in at least one memory 830 to perform various functions (e.g., functions or tasks supporting a method and system for linked smart accounts). Though a single processor 835 is depicted in the example of FIG. 8, it is to be understood that the user device 805 may include any quantity of one or more of processors 835 and that a group of processors 835 may collectively perform one or more functions ascribed herein to a processor, such as the processor 835. The processor 835 may be an example of a single processor or multiple processors. For example, the device 805 may include one or more processors 835.

For example, the client application 820 may be configured as or otherwise support a means for receiving, at a user device and from a third-party client application, a first request to provide an application-specific blockchain address with permissions to transfer funds from a global blockchain address, wherein the global blockchain address is an owner of a first smart contract associated with the application-specific blockchain address. The client application 820 may be configured as or otherwise support a means for receiving, at the user device and after receiving the first request, one or more first user inputs that result in a signature over a payload. The client application 820 may be configured as or otherwise support a means for broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

By including or configuring the client application 820 in accordance with examples as described herein, the device 805 may support techniques for linking blockchain wallet accounts, which may enable reduced latency and improved user experience related to reduced processing.

The client application 820 may include an application (e.g., “app”), program, software, extension, or other component which is configured to facilitate communications with a custodial token platform 110 on a server, one or more nodes of a blockchain network 105, other user devices 805, and other devices or systems. For example, the client application 820 may be an application executable on the user device 805, and the client application 820 may be configured to receive data from a custodial token platform 110, transmit data to the custodial token platform 110, process such data, and cause presentation of such data to a user via a user interface component 825. The client application 820 may be an example of a wallet application, a wallet device, or both, and may be associated with a wallet address and may access or use a private key to sign messages to facilitate transfer of crypto tokens, messages, transactions, or the like via a blockchain distributed data store.

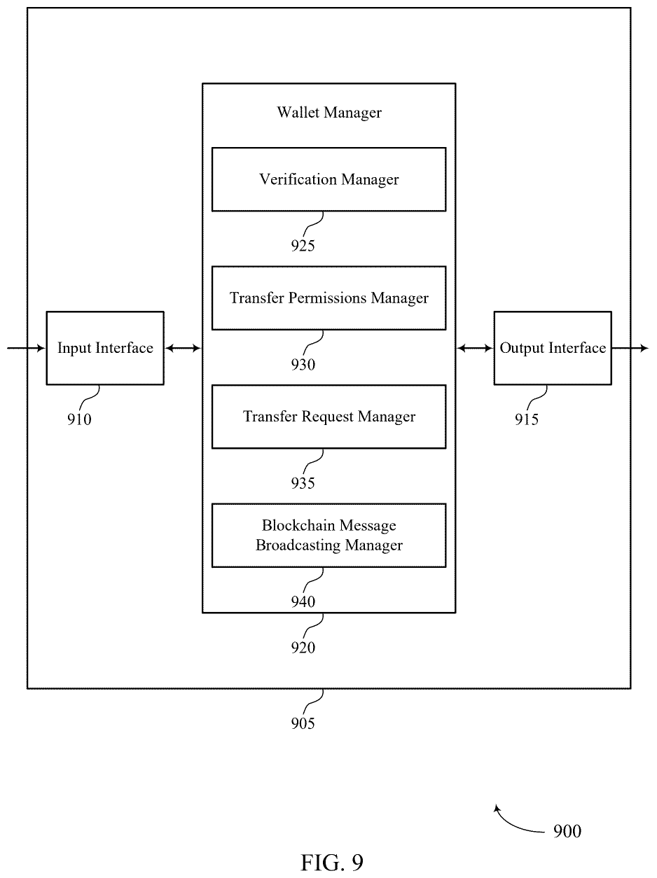

FIG. 9 shows a block diagram 900 of a device 905 that supports linked smart accounts in accordance with aspects of the present disclosure. The device 905 may include an input interface 910, an output interface 915, and a wallet manager 920. The device 905, or one or more components of the device 905 (e.g., the input interface 910, the output interface 915, the wallet manager 920), may include at least one processor, which may be coupled with at least one memory, to support the described techniques. Each of these components may be in communication with one another (e.g., via one or more buses).

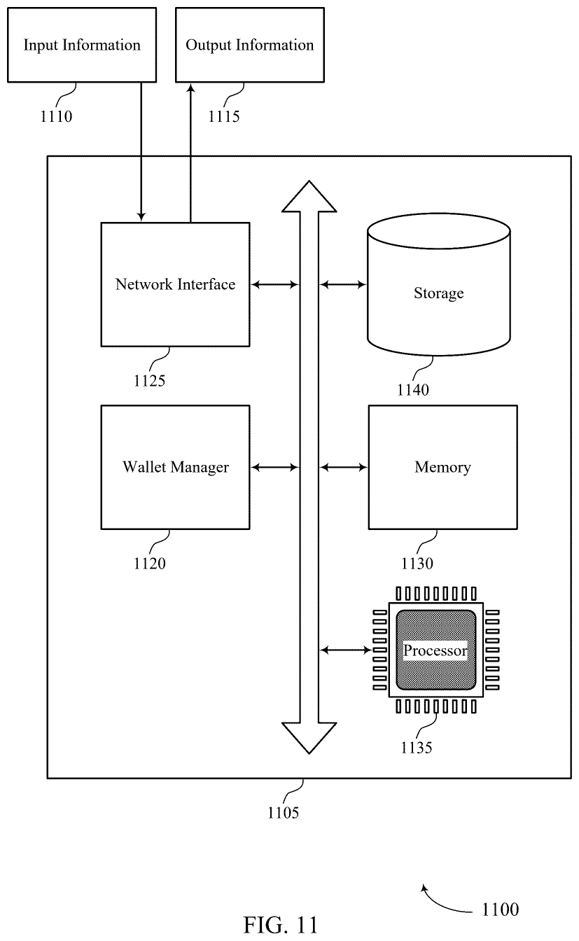

The input interface 910 may manage input signaling for the device 905. For example, the input interface 910 may receive input signaling (e.g., messages, packets, data, instructions, commands, transactions, or any other form of encoded information) from other systems or devices. The input interface 910 may send signaling corresponding to (e.g., representative of or otherwise based on) such input signaling to other components of the device 905 for processing. For example, the input interface 910 may transmit such corresponding signaling to the wallet manager 920 to support linked smart accounts. In some cases, the input interface 910 may be a component of a network interface 1125 as described with reference to FIG. 11.

The output interface 915 may manage output signaling for the device 905. For example, the output interface 915 may receive signaling from other components of the device 905, such as the wallet manager 920, and may transmit such output signaling corresponding to (e.g., representative of or otherwise based on) such signaling to other systems or devices. In some cases, the output interface 915 may be a component of a network interface 1125 as described with reference to FIG. 11.

For example, the wallet manager 920 may include a verification manager 925, a transfer permissions manager 930, a transfer request manager 935, a blockchain message broadcasting manager 940, or any combination thereof. In some examples, the wallet manager 920, or various components thereof, may be configured to perform various operations (e.g., receiving, monitoring, transmitting) using or otherwise in cooperation with the input interface 910, the output interface 915, or both. For example, the wallet manager 920 may receive information from the input interface 910, send information to the output interface 915, or be integrated in combination with the input interface 910, the output interface 915, or both to receive information, transmit information, or perform various other operations as described herein.

The verification manager 925 may be configured as or otherwise support a means for verifying, at one or more blockchain nodes, a first signature over a first payload that includes information that adds a global blockchain address of a user as an owner of a first smart contract associated with an application-specific blockchain address, wherein the first signature is associated with the application-specific blockchain address. The transfer permissions manager 930 may be configured as or otherwise support a means for receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address. The transfer request manager 935 may be configured as or otherwise support a means for receiving, at the second smart contract, a second payload that includes information to transfer an amount of the crypto token from the global blockchain address to the destination blockchain address. The verification manager 925 may be configured as or otherwise support a means for verifying, at the second smart contract, that the information to transfer satisfies the permission. The blockchain message broadcasting manager 940 may be configured as or otherwise support a means for broadcasting, after verifying the second signature, one or more messages that transfer the amount of the crypto token to the destination blockchain address.

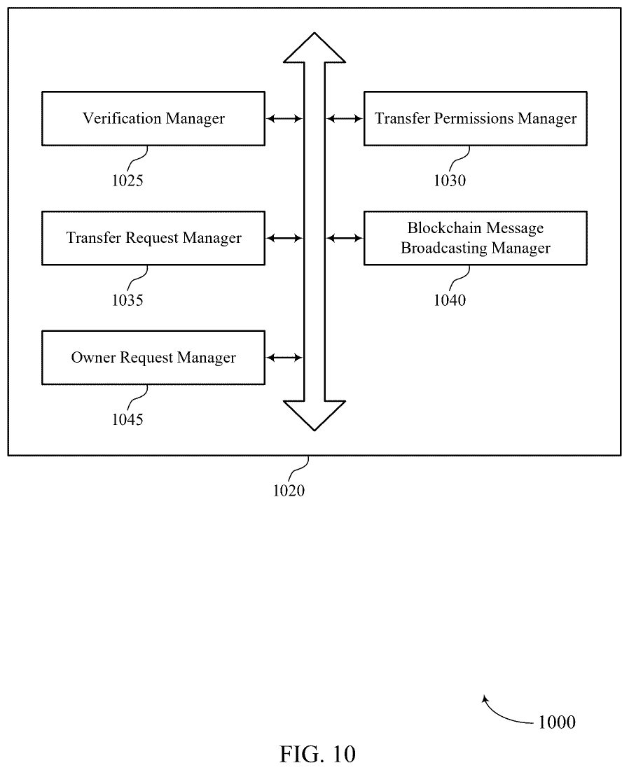

FIG. 10 shows a block diagram 1000 of a wallet manager 1020 that supports linked smart accounts in accordance with aspects of the present disclosure. The wallet manager 1020 may be an example of aspects of a wallet manager or a wallet manager 920, or both, as described herein. The wallet manager 1020, or various components thereof, may be an example of means for performing various aspects of linked smart accounts as described herein. For example, the wallet manager 1020 may include a verification manager 1025, a transfer permissions manager 1030, a transfer request manager 1035, a blockchain message broadcasting manager 1040, an owner request manager 1045, or any combination thereof. Each of these components, or components of subcomponents thereof (e.g., one or more processors, one or more memories), may communicate, directly or indirectly, with one another (e.g., via one or more buses).

The verification manager 1025 may be configured as or otherwise support a means for verifying, at one or more blockchain nodes, a first signature over a first payload that includes information that adds a global blockchain address of a user as an owner of a first smart contract associated with an application-specific blockchain address, wherein the first signature is associated with the application-specific blockchain address. The transfer permissions manager 1030 may be configured as or otherwise support a means for receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address. The transfer request manager 1035 may be configured as or otherwise support a means for receiving, at the second smart contract, a second payload that includes information to transfer an amount of the crypto token from the global blockchain address to the destination blockchain address. In some examples, the verification manager 1025 may be configured as or otherwise support a means for verifying, at the second smart contract, that the information to transfer satisfies the permission. The blockchain message broadcasting manager 1040 may be configured as or otherwise support a means for broadcasting, after verifying the second signature, one or more messages that transfer the amount of the crypto token to the destination blockchain address.

In some examples, the one or more messages transfer the amount of the crypto token from the global blockchain address to the application-specific blockchain address and from the application-specific blockchain address to the destination blockchain address.

In some examples, the verification manager 1025 may be configured as or otherwise support a means for verifying, at the second smart contract and after receiving the second payload, that the information to transfer satisfies a spend allowance defined by the permission.

In some examples, the owner request manager 1045 may be configured as or otherwise support a means for receiving, at the one or more blockchain nodes, a third payload that includes second information that adds the global blockchain address as the owner of a third smart contract associated with a second application-specific blockchain address.

In some examples, the transfer permissions manager 1030 may be configured as or otherwise support a means for receiving, at the second smart contract supported by the one or more blockchain nodes, an indication that the second application-specific blockchain address includes a second permission to transfer the crypto token from the global blockchain address to a second destination blockchain address.

In some examples, the one or more blockchain nodes store information that indicates that the global blockchain address is the owner of respective smart contracts associated with each of a plurality of linked blockchain addresses including the application-specific blockchain address.

In some examples, the second payload includes an indication of the permission and. In some examples, the second smart contract verifies the information to transfer based at least in part on the indication of the permission.

FIG. 11 shows a diagram of a system 1100 including a device 1105 that supports linked smart accounts in accordance with aspects of the present disclosure. The device 1105 may be an example of or include components of a device 905 as described herein. The device 1105 may include components for bi-directional voice and data communications including components for transmitting and receiving communications, such as a wallet manager 1120, an input information 1110, an output information 1115, a network interface 1125, at least one memory 1130, at least one processor 1135, and a storage 1140. Each of these components may communicate, directly or indirectly, with one another (e.g., via one or more buses, communications links, communications interfaces, or any combination thereof).

The network interface 1125 may enable the device 1105 to exchange information (e.g., input information 1110, output information 1115, or both) with other systems or devices (not shown). For example, the network interface 1125 may enable the device 1105 to connect to a network (e.g., a network 135 as described herein). The network interface 1125 may include one or more wireless network interfaces, one or more wired network interfaces, or any combination thereof.

Memory 1130 may include RAM, ROM, or both. The memory 1130 may store computer-readable, computer-executable software including instructions that, when executed, cause at least one processor 1135 to perform various functions described herein, such as functions supporting linked smart accounts. In some cases, the memory 1130 may contain, among other things, a basic input/output system (BIOS), which may control basic hardware or software operation such as the interaction with peripheral components or devices. In some cases, the memory 1130 may be an example of aspects of one or more components of a custodial token platform 110 as described with reference to FIG. 1. The memory 1130 may be an example of a single memory or multiple memories. For example, the device 1105 may include one or more memories 1130.

The processor 1135 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1135 may be configured to execute computer-readable instructions stored in at least one memory 1130 to perform various functions (e.g., functions or tasks supporting linked smart accounts). Though a single processor 1135 is depicted in the example of FIG. 11, it is to be understood that the device 1105 may include any quantity of one or more of processors 1135 and that a group of processors 1135 may collectively perform one or more functions ascribed herein to a processor, such as the processor 1135. The processor 1135 may be an example of a single processor or multiple processors. For example, the device 1105 may include one or more processors 1135.

Storage 1140 may be configured to store data that is generated, processed, stored, or otherwise used by the device 1105. In some cases, the storage 1140 may include one or more HDDs, one or more SDDs, or both. In some examples, the storage 1140 may be an example of a single database, a distributed database, multiple distributed databases, a data store, a data lake, or an emergency backup database. In some examples, the storage 1140 may be an example of one or more components described with reference to FIG. 1.

For example, the wallet manager 1120 may be configured as or otherwise support a means for verifying, at one or more blockchain nodes, a first signature over a first payload that including information that adds a global blockchain address of a user as an owner of a first smart contract associated with an application-specific blockchain address, wherein the first signature is associated with the application-specific blockchain address. The wallet manager 1120 may be configured as or otherwise support a means for receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address. The wallet manager 1120 may be configured as or otherwise support a means for receiving, at the second smart contract, a second payload that includes information to transfer an amount of the crypto token from the global blockchain address to the destination blockchain address. The wallet manager 1120 may be configured as or otherwise support a means for verifying, at the second smart contract, that the information to transfer satisfies the permission. The wallet manager 1120 may be configured as or otherwise support a means for broadcasting, after verifying the second signature, one or more messages that transfer the amount of the crypto token to the destination blockchain address.

By including or configuring the wallet manager 1120 in accordance with examples as described herein, the device 1105 may support techniques for linking blockchain wallet accounts, which may enable reduced latency and improved user experience.

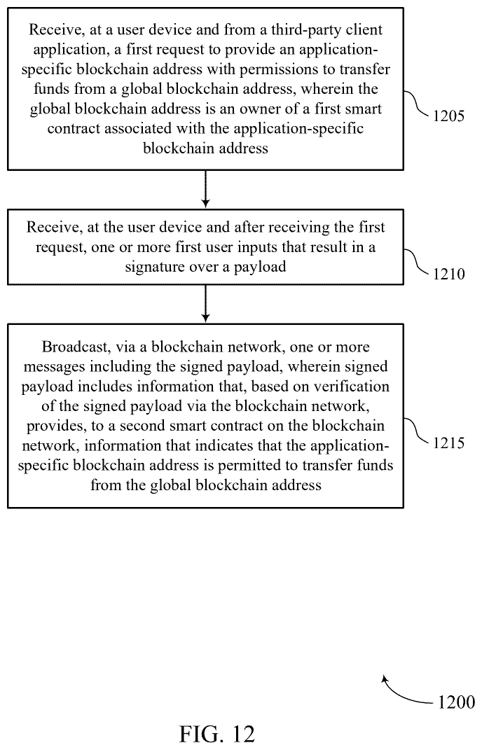

FIG. 12 shows a flowchart illustrating a method 1200 that supports linked smart accounts in accordance with aspects of the present disclosure. The operations of the method 1200 may be implemented by a user device or its components as described herein. For example, the operations of the method 1200 may be performed by a user device as described with reference to FIGS. 1 through 8. In some examples, a user device may execute a set of instructions to control the functional elements of the user device to perform the described functions. Additionally, or alternatively, the user device may perform aspects of the described functions using special-purpose hardware.

At 1205, the method may include receiving, at a user device and from a third-party client application, a first request to provide an application-specific blockchain address with permissions to transfer funds from a global blockchain address, wherein the global blockchain address is an owner of a first smart contract associated with the application-specific blockchain address. The operations of 1205 may be performed in accordance with examples as disclosed herein. In some examples, aspects of the operations of 1205 may be performed by a permissions request manager 725 as described with reference to FIG. 7.

At 1210, the method may include receiving, at the user device and after receiving the first request, one or more first user inputs that result in a signature over a payload. The operations of 1210 may be performed in accordance with examples as disclosed herein. In some examples, aspects of the operations of 1210 may be performed by a user input manager 730 as described with reference to FIG. 7.

At 1215, the method may include broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address. The operations of 1215 may be performed in accordance with examples as disclosed herein. In some examples, aspects of the operations of 1215 may be performed by a blockchain message broadcasting manager 735 as described with reference to FIG. 7.

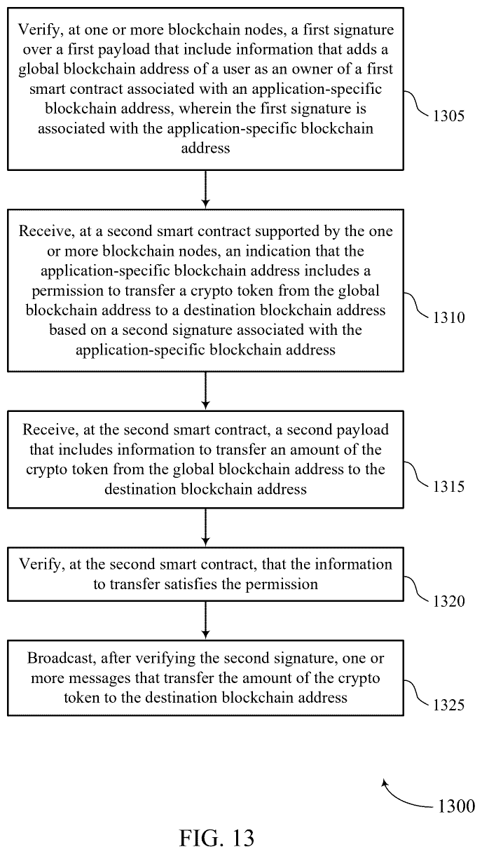

FIG. 13 shows a flowchart illustrating a method 1300 that supports linked smart accounts in accordance with aspects of the present disclosure. The operations of the method 1300 may be implemented by a custodial token platform or its components as described herein. For example, the operations of the method 1300 may be performed by a custodial token platform as described with reference to FIGS. 1 through 5 and 9 through 11. In some examples, a custodial token platform may execute a set of instructions to control the functional elements of the custodial token platform to perform the described functions. Additionally, or alternatively, the custodial token platform may perform aspects of the described functions using special-purpose hardware.

At 1305, the method may include verifying, at one or more blockchain nodes, a first signature over a first payload that includes information that adds a global blockchain address of a user as an owner of a first smart contract associated with an application-specific blockchain address, wherein the first signature is associated with the application-specific blockchain address. The operations of 1305 may be performed in accordance with examples as disclosed herein. In some examples, aspects of the operations of 1305 may be performed by a verification manager 1025 as described with reference to FIG. 10.

At 1310, the method may include receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address. The operations of 1310 may be performed in accordance with examples as disclosed herein. In some examples, aspects of the operations of 1310 may be performed by a transfer permissions manager 1030 as described with reference to FIG. 10.

At 1315, the method may include receiving, at the second smart contract, a second payload that includes information to transfer an amount of the crypto token from the global blockchain address to the destination blockchain address. The operations of 1315 may be performed in accordance with examples as disclosed herein. In some examples, aspects of the operations of 1315 may be performed by a transfer request manager 1035 as described with reference to FIG. 10.

At 1320, the method may include verifying, at the second smart contract, that the information to transfer satisfies the permission. The operations of 1320 may be performed in accordance with examples as disclosed herein. In some examples, aspects of the operations of 1320 may be performed by a verification manager 1025 as described with reference to FIG. 10.

At 1325, the method may include broadcasting, after verifying the second signature, one or more messages that transfer the amount of the crypto token to the destination blockchain address. The operations of 1325 may be performed in accordance with examples as disclosed herein. In some examples, aspects of the operations of 1325 may be performed by a blockchain message broadcasting manager 1040 as described with reference to FIG. 10.

A method by an apparatus is described. The method may include receiving, at a user device and from a third-party client application, a first request to provide an application-specific blockchain address with permissions to transfer funds from a global blockchain address, wherein the global blockchain address is an owner of a first smart contract associated with the application-specific blockchain address, receiving, at the user device and after receiving the first request, one or more first user inputs that result in a signature over a payload, and broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

An apparatus is described. The apparatus may include one or more memories storing processor executable code, and one or more processors coupled with the one or more memories. The one or more processors may individually or collectively be operable to execute the code to cause the apparatus to receive, at a user device and from a third-party client application, a first request to provide an application-specific blockchain address with permissions to transfer funds from a global blockchain address, wherein the global blockchain address is an owner of a first smart contract associated with the application-specific blockchain address, receive, at the user device and after receiving the first request, one or more first user inputs that result in a signature over a payload, and broadcast, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

Another apparatus is described. The apparatus may include means for receiving, at a user device and from a third-party client application, a first request to provide an application-specific blockchain address with permissions to transfer funds from a global blockchain address, wherein the global blockchain address is an owner of a first smart contract associated with the application-specific blockchain address, means for receiving, at the user device and after receiving the first request, one or more first user inputs that result in a signature over a payload, and means for broadcasting, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

A non-transitory computer-readable medium storing code is described. The code may include instructions executable by one or more processors to receive, at a user device and from a third-party client application, a first request to provide an application-specific blockchain address with permissions to transfer funds from a global blockchain address, wherein the global blockchain address is an owner of a first smart contract associated with the application-specific blockchain address, receive, at the user device and after receiving the first request, one or more first user inputs that result in a signature over a payload, and broadcast, via a blockchain network, one or more messages including the signed payload, wherein signed payload includes information that, based on verification of the signed payload via the blockchain network, provides, to a second smart contract on the blockchain network, information that indicates that the application-specific blockchain address is permitted to transfer funds from the global blockchain address.

Some examples of the method, apparatus, and non-transitory computer-readable medium described herein may further include operations, features, means, or instructions for receive one or more second user inputs to transfer a first type of crypto token from the global blockchain address, displaying, at the user device, a user interface that includes one or more blockchain addresses linked to the global blockchain address and including the application-specific blockchain address, receiving a third user input that selects, for supporting the transfer of the first type of crypto token, the application-specific blockchain address from the one or more blockchain addresses, and broadcasting, after receiving the third user input, one or more second messages that transfer the first type of the crypto token from the application-specific blockchain address instead of the global blockchain address.

In some examples of the method, apparatus, and non-transitory computer-readable medium described herein, the one or more blockchain addresses may be linked to the global blockchain address based at least in part on the global blockchain address being designated as the owner of each respective smart contract associated with of the one or more blockchain addresses.

In some examples of the method, apparatus, and non-transitory computer-readable medium described herein, the one or more messages transfer the first type of crypto token from the global blockchain address to the application-specific blockchain address and from the application-specific blockchain address to a destination blockchain address.

Some examples of the method, apparatus, and non-transitory computer-readable medium described herein may further include operations, features, means, or instructions for receiving, from the third-party client application and prior to the first request, a second request to add the global blockchain address as the owner of the first smart contract associated with the application-specific blockchain address, receiving, after receiving the second request, a second signature over a second payload, wherein the second signature may be associated with the application-specific blockchain address, and broadcasting one or more second message, the signed second payload that includes information that adds the global blockchain address as the owner of the first smart contract associated with the application-specific blockchain address.

Some examples of the method, apparatus, and non-transitory computer-readable medium described herein may further include operations, features, means, or instructions for receiving, at the user device and from the third-party client application, a second request to generate the application-specific blockchain address associated with the third-party client application, receiving one or more second user inputs that result in generation of the application-specific blockchain address associated with the third-party client application, and storing, at the user device, a passkey associated with the application-specific blockchain address.

Some examples of the method, apparatus, and non-transitory computer-readable medium described herein may further include operations, features, means, or instructions for displaying, at a user interface of the user device, an indication of the permissions requested by the third-party client application, wherein the one or more first user inputs may be received after displaying the indication of the permissions.

Some examples of the method, apparatus, and non-transitory computer-readable medium described herein may further include operations, features, means, or instructions for displaying, at the user device, a user interface including a plurality of crypto tokens associated with the global blockchain address, wherein the plurality of crypto tokens includes one or more crypto token types associated with one or more blockchain addresses which may be linked to the global blockchain address.

A method by an apparatus is described. The method may include verifying, at one or more blockchain nodes, a first signature over a first payload that includes information that adds a global blockchain address of a user as an owner of a first smart contract associated with an application-specific blockchain address, wherein the first signature is associated with the application-specific blockchain address, receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address, receiving, at the second smart contract, a second payload that includes information to transfer an amount of the crypto token from the global blockchain address to the destination blockchain address, verifying, at the second smart contract, that the information to transfer satisfies the permission, and broadcasting, after verifying the second signature, one or more messages that transfer the amount of the crypto token to the destination blockchain address.

An apparatus is described. The apparatus may include one or more memories storing processor executable code, and one or more processors coupled with the one or more memories. The one or more processors may individually or collectively be operable to execute the code to cause the apparatus to verifying, at one or more blockchain nodes, a first signature over a first payload that include information that adds a global blockchain address of a user as an owner of a first smart contract associated with an application-specific blockchain address, wherein the first signature is associated with the application-specific blockchain address, receive, at a second smart contract supported by the one or more blockchain nodes, an indication that the application-specific blockchain address includes a permission to transfer a crypto token from the global blockchain address to a destination blockchain address based on a second signature associated with the application-specific blockchain address, receive, at the second smart contract, a second payload that includes information to transfer an amount of the crypto token from the global blockchain address to the destination blockchain address, verifying, at the second smart contract, that the information to transfer satisfies the permission, and broadcast, after verifying the second signature, one or more messages that transfer the amount of the crypto token to the destination blockchain address.

Another apparatus is described. The apparatus may include means for verifying, at one or more blockchain nodes, a first signature over a first payload that includes information that adds a global blockchain address of a user as an owner of a first smart contract associated with an application-specific blockchain address, wherein the first signature is associated with the application-specific blockchain address, means for receiving, at a second smart contract supported by the one or more blockchain nodes, an indication that the application-specific blockchain address includes a permission to transfer a crypto token from the global blockchain address to a destination blockchain address based on a second signature associated with the application-specific blockchain address, means for receiving, at the second smart contract, a second payload that includes information to transfer an amount of the crypto token from the global blockchain address to the destination blockchain address, means for verifying, at the second smart contract, that the information to transfer satisfies the permission, and means for broadcasting, after verifying the second signature, one or more messages that transfer the amount of the crypto token to the destination blockchain address.

A non-transitory computer-readable medium storing code is described. The code may include instructions executable by one or more processors to verifying, at one or more blockchain nodes, a first signature over a first payload that include information that adds a global blockchain address of a user as an owner of a first smart contract associated with an application-specific blockchain address, wherein the first signature is associated with the application-specific blockchain address, receive, at a second smart contract supported by the one or more blockchain nodes, an indication that the application-specific blockchain address includes a permission to transfer a crypto token from the global blockchain address to a destination blockchain address based on a second signature associated with the application-specific blockchain address, receive, at the second smart contract, a second payload that includes information to transfer an amount of the crypto token from the global blockchain address to the destination blockchain address, verifying, at the second smart contract, that the information to transfer satisfies the permission, and broadcast, after verifying the second signature, one or more messages that transfer the amount of the crypto token to the destination blockchain address.

In some examples of the method, apparatus, and non-transitory computer-readable medium described herein, the one or more messages transfer the amount of the crypto token from the global blockchain address to the application-specific blockchain address and from the application-specific blockchain address to the destination blockchain address.

In some examples of the method, apparatus, and non-transitory computer-readable medium described herein, verifying, at the second smart contract and after receiving the second payload, that the information to transfer satisfies a spend allowance defined by the permission.

Some examples of the method, apparatus, and non-transitory computer-readable medium described herein may further include operations, features, means, or instructions for receiving, at the one or more blockchain nodes, a third payload that includes second information that adds the global blockchain address as the owner of a third smart contract associated with a second application-specific blockchain address.

Some examples of the method, apparatus, and non-transitory computer-readable medium described herein may further include operations, features, means, or instructions for receiving, at the second smart contract supported by the one or more blockchain nodes, an indication that the second application-specific blockchain address includes a second permission to transfer the crypto token from the global blockchain address to a second destination blockchain address.

In some examples of the method, apparatus, and non-transitory computer-readable medium described herein, the one or more blockchain nodes store information that indicates that the global blockchain address may be the owner of respective smart contracts associated with each of a plurality of linked blockchain addresses including the application-specific blockchain address.

In some examples of the method, apparatus, and non-transitory computer-readable medium described herein, the second payload includes an indication of the permission and the second smart contract verifies the information to transfer based at least in part on the indication of the permission.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
receiving, at a user device and from a third-party client application, a first request message requesting permissions for an application-specific blockchain address to transfer funds from a global blockchain address, wherein the global blockchain address is designated, via a blockchain ledger of a blockchain network, as an owner of a first smart contract associated with the application-specific blockchain address;
receiving, via a user interface of the user device and after receiving the first request, one or more first user inputs approving the permissions;
generating a signature over a permissions payload using a private key associated with the global blockchain address, the permissions payload defining spend limits for the application-specific blockchain address to transfer crypto tokens from the global blockchain address; and
storing the signed permissions payload to a spend permissions manager smart contract on the blockchain network by broadcasting one or more messages including the signed permissions payload, the spend permissions manager smart contract providing access for the application-specific blockchain address to subsequently transfer funds from the global blockchain address according to the defined spend limits without requiring additional user signatures.

2. The method of claim 1, further comprising:
receiving one or more second user inputs to transfer a first type of crypto token from the global blockchain address;
displaying, at the user device, a user interface that includes one or more additional blockchain addresses linked to the global blockchain address and including the application-specific blockchain address;
receiving a third user input that selects, for supporting the transfer of the first type of crypto token, the application-specific blockchain address from the one or more additional blockchain addresses; and
broadcasting, after receiving the third user input, one or more second messages that include call information to the spend permissions manager smart contract, wherein the call information specifies the stored permissions, an amount of the first type of crypto token to transfer, and a recipient address associated with the third-party client application, and wherein the spend permissions manager smart contract uses the call information to transfer the first type of the crypto token from the global blockchain address to the application-specific blockchain address and then from the application-specific blockchain address to the recipient address based on the stored permissions.

3. The method of claim 2, wherein the one or more additional blockchain addresses are linked to the global blockchain address based at least in part on the global blockchain address being designated as the owner of each respective smart contract associated with the one or more additional blockchain addresses.

4. The method of claim 2, further comprising:
transferring, based at least in part on broadcasting the one or more messages, the first type of crypto token from the global blockchain address to the application-specific blockchain address and from the application-specific blockchain address to a destination blockchain address.

5. The method of claim 1, further comprising:
receiving, from the third-party client application and prior to the first request, a second request to add the global blockchain address as the owner of the first smart contract associated with the application-specific blockchain address;
receiving, after receiving the second request, a second signature over a second permissions payload, wherein the second signature is associated with the application-specific blockchain address; and
broadcasting one or more second messages including the signed second permissions payload that includes information that adds the global blockchain address as the owner of the first smart contract associated with the application-specific blockchain address.

6. The method of claim 1, further comprising:
receiving, at the user device and from the third-party client application prior to receiving the first request, a second request to generate the application-specific blockchain address associated with the third-party client application;
receiving, prior to receiving the one or more first user inputs, one or more second user inputs that result in generation of the application-specific blockchain address associated with the third-party client application; and
storing, at the user device, a passkey associated with the application-specific blockchain address.

7. The method of claim 1, further comprising:
displaying, at a user interface of the user device and prior to receiving the one or more first user inputs, an indication of the permissions requested by the third-party client application.

8. The method of claim 1, further comprising:
displaying, at the user device, a user interface including a plurality of crypto tokens associated with the global blockchain address, wherein the plurality of crypto tokens includes one or more crypto token types associated with one or more additional blockchain addresses which are linked to the global blockchain address based on the global blockchain address being designated, via the blockchain ledger, as the owner of respective smart contracts associated with the one or more additional blockchain addresses.

9-20. (canceled)

21. An apparatus, comprising:
one or more memories storing processor-executable code; and
one or more processors coupled with the one or more memories individually or collectively operable to execute the code to cause the apparatus to:
receive, at a user device and from a third-party client application, a first request message requesting permissions for an application-specific blockchain address to transfer funds from a global blockchain address, wherein the global blockchain address is designated, via a blockchain ledger of a blockchain network, as an owner of a first smart contract associated with the application-specific blockchain address;
receive, via a user interface of the user device and after receiving the first request, one or more first user inputs approving the permissions;
generate a signature over a permissions payload using a private key associated with the global blockchain address, the permissions payload defining spend limits for the application-specific blockchain address to transfer crypto tokens from the global blockchain address; and
store the signed permissions payload to a spend permissions manager smart contract on the blockchain network by broadcasting one or more messages including the signed permissions payload, the spend permissions manager smart contract providing access for the application-specific blockchain address to subsequently transfer funds from the global blockchain address according to the defined spend limits without requiring additional user signatures.

22. The apparatus of claim 21, wherein the one or more processors are individually or collectively further operable to execute the code to cause the apparatus to:
receive one or more second user inputs to transfer a first type of crypto token from the global blockchain address;
display, at the user device, a user interface that includes one or more additional blockchain addresses linked to the global blockchain address and including the application-specific blockchain address;
receive a third user input that selects, for supporting the transfer of the first type of crypto token, the application-specific blockchain address from the one or more additional blockchain addresses; and
broadcast, after receiving the third user input, one or more second messages that include call information to the spend permissions manager smart contract, wherein the call information specifies the stored permissions, an amount of the first type of crypto token to transfer, and a recipient address associated with the third-party client application, and wherein the spend permissions manager smart contract uses the call information to transfer the first type of the crypto token from the global blockchain address to the application-specific blockchain address and then from the application-specific blockchain address to the recipient address based on the stored permissions.

23. The apparatus of claim 22, wherein the one or more additional blockchain addresses are linked to the global blockchain address based at least in part on the global blockchain address being designated as the owner of each respective smart contract associated with the one or more additional blockchain addresses.

24. The apparatus of claim 22, wherein the one or more processors are individually or collectively further operable to execute the code to cause the apparatus to:
transfer, based at least in part on broadcasting the one or more messages, the first type of crypto token from the global blockchain address to the application-specific blockchain address and from the application-specific blockchain address to a destination blockchain address.

25. The apparatus of claim 21, wherein the one or more processors are individually or collectively further operable to execute the code to cause the apparatus to:
receive, from the third-party client application and prior to the first request, a second request to add the global blockchain address as the owner of the first smart contract associated with the application-specific blockchain address;
receive, after receiving the second request, a second signature over a second permissions payload, wherein the second signature is associated with the application-specific blockchain address; and
broadcast one or more second messages including the signed second permissions payload that includes information that adds the global blockchain address as the owner of the first smart contract associated with the application-specific blockchain address.

26. The apparatus of claim 21, wherein the one or more processors are individually or collectively further operable to execute the code to cause the apparatus to:
receive, at the user device and from the third-party client application prior to receiving the first request, a second request to generate the application-specific blockchain address associated with the third-party client application;
receive, prior to receiving the one or more first user inputs, one or more second user inputs that result in generation of the application-specific blockchain address associated with the third-party client application; and
store, at the user device, a passkey associated with the application-specific blockchain address.

27. The apparatus of claim 21, wherein the one or more processors are individually or collectively further operable to execute the code to cause the apparatus to:
display, at a user interface of the user device and prior to receiving the one or more first user inputs, an indication of the permissions requested by the third-party client application.

28. The apparatus of claim 21, wherein the one or more processors are individually or collectively further operable to execute the code to cause the apparatus to:
display, at the user device, a user interface including a plurality of crypto tokens associated with the global blockchain address, wherein the plurality of crypto tokens includes one or more crypto token types associated with one or more additional blockchain addresses which are linked to the global blockchain address based on the global blockchain address being designated, via the blockchain ledger, as the owner of respective smart contracts associated with the one or more additional blockchain addresses.

29. A non-transitory computer-readable medium storing code, the code comprising instructions executable by one or more processors to:
receive, at a user device and from a third-party client application, a first request message requesting permissions for an application-specific blockchain address to transfer funds from a global blockchain address, wherein the global blockchain address is designated, via a blockchain ledger of a blockchain network, as an owner of a first smart contract associated with the application-specific blockchain address;
receive, via a user interface of the user device and after receiving the first request, one or more first user inputs approving the permissions;
generate a signature over a permissions payload using a private key associated with the global blockchain address, the permissions payload defining spend limits for the application-specific blockchain address to transfer crypto tokens from the global blockchain address; and
store the signed permissions payload to a spend permissions manager smart contract on the blockchain network by broadcasting one or more messages including the signed permissions payload, the spend permissions manager smart contract providing access for cryptographically the application-specific blockchain address to subsequently transfer funds from the global blockchain address according to the defined spend limits without requiring additional user signatures.

30. The non-transitory computer-readable medium of claim 29, wherein the instructions are further executable by the one or more processors to:
receive one or more second user inputs to transfer a first type of crypto token from the global blockchain address;
display, at the user device, a user interface that includes one or more additional blockchain addresses linked to the global blockchain address and including the application-specific blockchain address;
receive a third user input that selects, for supporting the transfer of the first type of crypto token, the application-specific blockchain address from the one or more additional blockchain addresses; and
broadcast, after receiving the third user input, one or more second messages that include call information to the spend permissions manager smart contract, wherein the call information specifies the stored permissions, an amount of the first type of crypto token to transfer, and a recipient address associated with the third-party client application, and wherein the spend permissions manager smart contract uses the call information to transfer the first type of the crypto token from the global blockchain address to the application-specific blockchain address and then from the application-specific blockchain address to the recipient address based on the stored permissions.

31. The non-transitory computer-readable medium of claim 30, wherein the one or more additional blockchain addresses are linked to the global blockchain address based at least in part on the global blockchain address being designated as the owner of each respective smart contract associated with the one or more additional blockchain addresses.

32. The non-transitory computer-readable medium of claim 30, wherein the one or more messages transfer the first type of crypto token from the global blockchain address to the application-specific blockchain address and from the application-specific blockchain address to a destination blockchain address.
